(19) United States
(12) Patent Application Publication
(10) Pub. No.: US 2024/0276975 A1
(43) Pub. Date: Aug. 22, 2024

(54) PORTABLE OBSERVATION STAND AND BLIND

(71) Applicant: Fabian Ramirez, Green Bay, WI (US)

(72) Inventor: Fabian Ramirez, Green Bay, WI (US)

(21) Appl. No.: 18/431,416

(22) Filed: Feb. 2, 2024

Related U.S. Application Data
(60) Provisional application No. 63/447,139, filed on Feb. 21, 2023.

(51) Int. Cl. A01M 31/02

(52) U.S. Cl. CPC A01M 31/025

(57) ABSTRACT

A stand comprising a platform and a telescoping leg is disclosed. The platform comprises a pivotable joint coupled to the telescoping leg. The pivotable joint is rotatable between a collapsed position and a locked position. The telescoping leg comprises a removable rung coupled to the telescoping leg, a first segment of the telescoping leg, and a second segment of the telescoping leg partially captured within and slidably supported by the first segment.

### CROSS-REFERENCE TO RELATED APPLICATIONS

This application claims the benefit of U.S. Provisional Application No. 63/447,139 filed on Feb. 21, 2023, which is incorporated herein in its entirety.

### TECHNICAL FIELD

This disclosure relates to systems and methods for a portable observation stand and blind. More specifically, this disclosure relates to portable observation stands, such as hunting stands, that may be carried on an operator's back and assembled and disassembled in the field.

### BACKGROUND

Observation stands can elevate the operator's position on a platform relative to the ground. Portable observation stands can provide many useful purposes for lifting, elevating, and supporting the operator vertically above the ground. Example uses include, but are not limited to, observation, inspection, and/or supporting a worker doing repairs above ground (e.g., an electrician working on telephone and/or electric overhead wires). In another example, hunters often use observation stands to elevate themselves above prey and/or wait for approaching prey.

One technique commonly used in hunting stands is to incorporate a blind, partially or entirely, surrounding the platform to obscure the hunter within the stand. The blind may eliminate or reduce the prey's visual and/or olfactory senses until the hunter can ambush and dispatch the prey.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a stand comprising a platform. The platform comprises a pivotable joint coupled to a telescoping leg. The telescoping leg is coupled to the platform at the pivotable joint and rotates between collapsed and locked positions. The telescoping leg comprises a removable rung coupled to the telescoping leg, a first segment of the telescoping leg, and a second segment of the telescoping leg partially captured within and slidably supported by the first segment.

In a further aspect, disclosed is a portable observation stand and blind system. The system comprises a platform, a blind, and at least three telescoping legs. The platform comprises a pivotable joint. The blind is coupled to the platform and extends at least partially about the platform. The telescoping legs are coupled to the platform at the pivotable joint. Each telescoping leg can rotate between a collapsed position and a locked position. Each telescoping leg comprises a removable rung coupled to the telescoping leg, a first segment of the telescoping leg, and a second segment of the telescoping leg partially captured within and slidably supported by the first segment.

In yet another aspect, disclosed is a method of erecting a portable observation stand. The method comprises carrying a platform coupled to three or more telescoping legs. Each telescoping leg is rotated into a locked position relative to the platform. The operator extends each telescoping leg by coupling a second segment of each telescoping leg captured within the first segment of the telescoping leg.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, serve to explain various principles of the disclosure. The drawings are not necessarily drawn to scale. Corresponding features and components throughout the Figures may be designated by matching reference characters for the sake of consistency and clarity.

FIG. 1 is an elevated side representation of a portable observation stand in accordance with one aspect of the current disclosure.

FIG. 2 is a top view of the stand of FIG. 1 showing a platform extending about a seat.

FIG. 3 is an elevated side representation of the portable observation stand of FIG. 1, showing a backrest installed behind the seat.

FIG. 4 is a top view of the seat of FIG. 3, showing slots within the seat to receive and support the backrest in accordance with an aspect of the current disclosure.

FIG. 5 is a perspective view of an operator carrying the portable observation stand in a collapsed position.

FIG. 6 is a side perspective view of the portable observation stand in the collapsed position.

FIG. 7 is a side perspective view of the portable observation stand in an open unextended position.

FIG. 8 is a side perspective view of a portable observation stand connection with a first leg in a loosened position.

FIG. 9 is a side perspective view of the portable observation stand connection with the first leg in a tightened position.

FIG. 10 is a side perspective view of the portable observation stand in the open unextended position where each leg is tightened.

FIG. 11 is a side perspective view of the first leg in an extended position.

FIG. 12 is a side perspective view of the first leg in a locked extended position.

FIG. 13 is a side perspective view of a step coupled to a leg of the portable observation stand.

FIG. 14 is a side perspective view of an operator climbing a series of steps coupled to a leg of the portable observation stand.

FIG. 15 is a side perspective view of an operator seated in the seat of the portable observation stand.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

In one aspect, a system comprising a portable observation stand that can be carried into a field and erected is described. Associated methods, systems, devices, and various apparatuses are further disclosed herein. The system can comprise feet, a blind, accessories, and a stand comprising telescoping legs coupled to a platform and supporting a seat.

One aspect of a portable observation stand 100 is disclosed and described in FIG. 1. FIG. 1 is an elevated side representation of the portable observation stand 100. Stand 100 can comprise a platform 102 and at least one telescoping leg 104. The telescoping leg 104 can have two or more segments, shown as a first segment 106 and a second segment 108. Platform 102 can be coupled to the telescoping leg 104 with a pivotable joint 110.

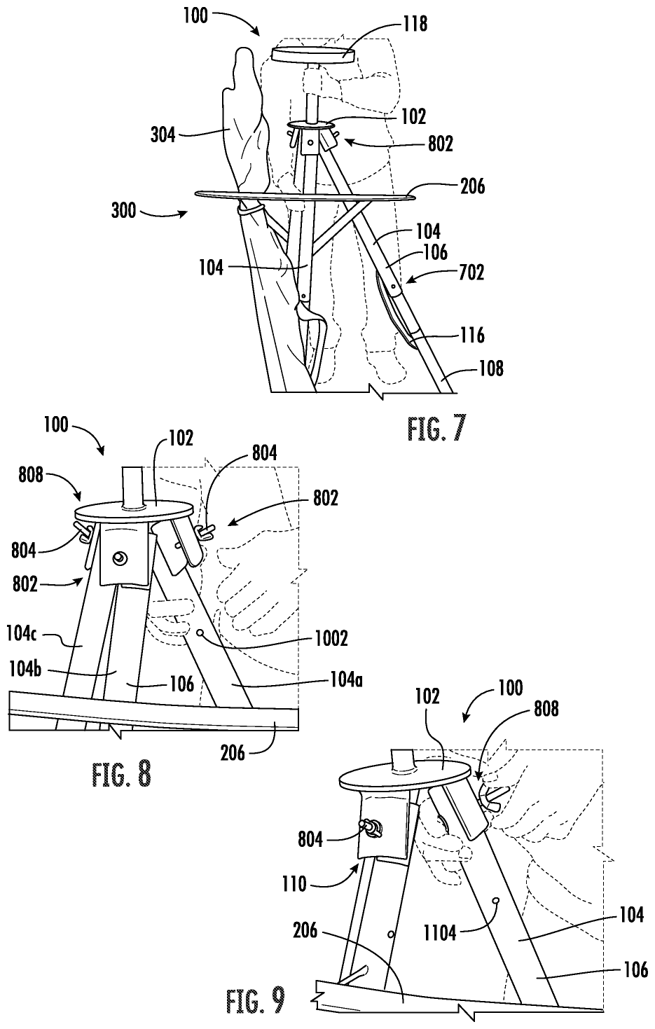

The pivotable joint 110 can facilitate rotating the telescoping leg 104 relative to the platform 102 between a collapsed position 502 (FIG. 5) and a locked position 112 (FIG. 1). As described in greater detail below, the telescoping leg 104 can be in a locked and retracted position 702 (FIG. 7) where the second segment 108 is not extended relative to the first segment 106, or the telescoping leg 104 can be in a partially or fully extracted/extended and locked in a locked position 112 where the second segment 108 can extend axially from the first segment 106. The portable observation stand 100 can comprise a first telescoping leg 104a, a second telescoping leg 104b, and/or a third telescoping leg 104c.

Stand 100 comprises first, second, and third telescoping legs 104a,b,c, where each telescoping leg 104 can comprise the first segment 106, and the second segment 108 can be partially captured within and slidably supported by the first segment 106 of the telescoping leg 104. Each telescoping leg 104 may comprise substantially the same features and/or be interchangeable. Each telescoping leg 104 can support one or more removable rungs 114 and/or straps 116.

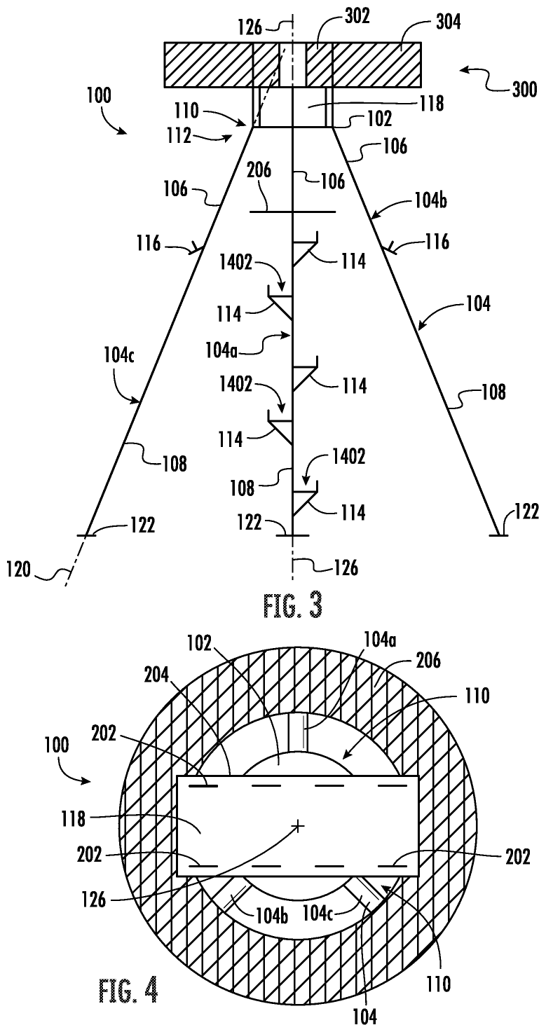

The telescoping leg 104 (e.g., telescoping leg 104a in FIGS. 1 and 3) can comprise at least one removable rung 114 coupled to the telescoping leg 104 to facilitate an operator climbing up the telescoping leg 104 to a seat 118 on platform 102. It is understood, that any or all of the telescoping legs 104a,b,c can comprise one or more rungs 114 orientated on or about the leg 104 in various aspects to enhance the functionality of the observation stand 100 and provide access points to add various attachments (e.g., footrest 206, straps, rung 114, and/or storage compartments for firearms, bows, ammunition (bullets and/or arrows), tools, supplies, binoculars, snacks, etc.). That is, the rungs 114 provide an access point to attach various components to the telescoping leg 104 and provide the operator customizability and versatility in the arrangement of the observation stand.

The first segment 106 of the telescoping leg 104 can be substantially hollow and/or comprise a circular, rectangular, and/or square cross-sectional shape. The second segment 108 of the telescoping leg 104 can be partially surrounded by and/or captured within the first segment 106 of the telescoping leg 104. For example, the second segment 108 can be slidably supported by the first segment 106 to extend along an axial axis 120 of the telescoping leg 104.

In various aspects, some or all of the telescoping legs 104 can comprise a foot 122 coupled to the telescoping leg 104, e.g., at a distal end of the second segment 108. For example, a stand 100 comprising at least three telescoping legs 104a,b,c can comprise at least three feet 122, each of the feet 122 attached to a corresponding one of the telescoping legs 104. Each foot 122 can be coupled to an end near the foot 122 of each telescoping leg 104 opposite the platform 102.

The foot 122 can comprise a larger surface area than the distal end of the second segment 108 and can distribute forces along a ground under the telescoping leg 104. For example, foot 122 can comprise a guard 124 coupled to the foot 122 that provides semi-rigid support to foot 122, e.g., in wetlands, swampy areas, or snow. The foot 122 and/or guard 124 can function to distribute the point forces at the end of each telescoping leg 104 to the ground and stabilize the observation stand 100 in wet environments (e.g., mud or snow) or on uneven ground and/or sloped terrain.

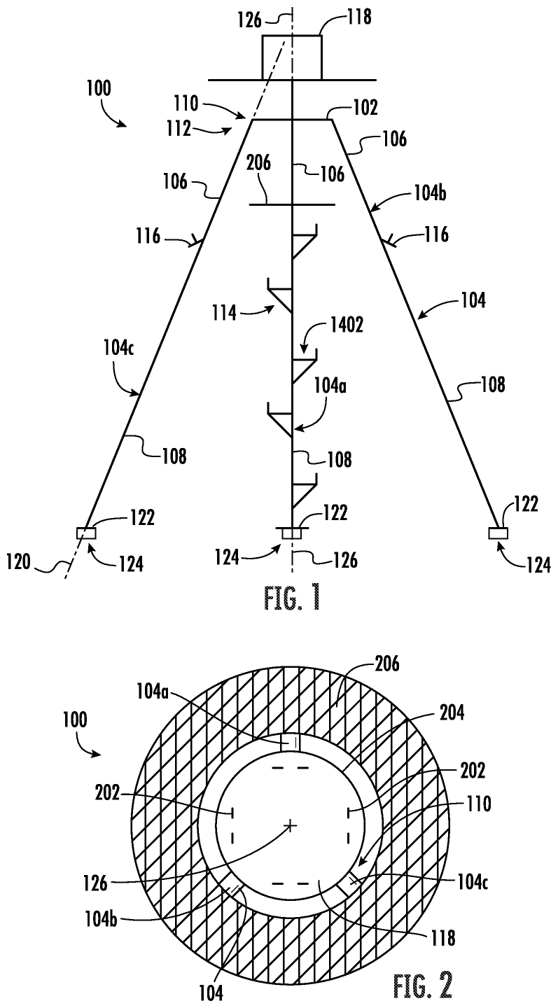

FIG. 2 shows a top view of stand 100, showing platform 102 (FIG. 1) extending about seat 118. Seat 118 is shown as a circular section that can support an operator. The telescoping legs 104 can be pivoted into the locked position 112, and seat 118 can comprise slots 202 extending within a perimeter 204 of seat 118. A pair of the slots 202 can receive an insert from a backrest or a blind into seat 118 and/or platform 102. FIG. 2 shows a footrest 206 extending 360 degrees about seat 118 and platform 102, such that an operator can sit on seat 118 and rotate 360 degrees to face in any desired direction. The footrest 206 shown in FIG. 2 is different from the footrest 206 shown in FIG. 1 because it attaches to each telescoping leg 104 and completely surrounds platform 102. In various aspects, seat 118 and/or the platform 102 can rotate such that the operator's body remains stationary relative to seat 118, but footrest 206 rotates under the operator as the direction changes. In various aspects, the height of footrest 206, seat 118, and/or platform 102 can be adjustable by the operator and can be configured for the size and dimensions of the operator's body. In this way, the stand 100 can be adjusted to accommodate a small child to a grown adult and/or may accommodate different genders and/or body statures. As the footrest 206 is attached or coupled to at least one telescoping leg 104, and in some cases more than one telescoping leg 104, it can serve as a firm foundation for the operator's foot so that the operator can push off the footrest 206 to reorient the operator's body position and/or rotate on or about the seat 118.

FIG. 3 is an elevated side representation of the portable observation stand 100 with a portable observation stand system 300 showing a backrest 302 installed behind seat 118. As described above, the backrest 302 can be inserted into slots 202 (FIG. 1) within seat 118 to stabilize the backrest 302 relative to seat 118. The backrest 302 can rotate with seat 118 about platform 102, while the footrest 206 is positioned about and/or below the platform 102 and can be attached to the telescoping leg(s) 104 below the platform 102 to encircle partially or entirely around the platform 102 and/or telescoping leg(s) 104. In some aspects, the footrest 206 may be attached to a single telescoping leg 104, and the backrest 302 can support the operator to observe in a single direction. That is, seat 118 and/or backrest 302 can be configured to be stationary relative to a pivot axis 126, and the footrest 206 can partially encircle one or more telescoping legs 104, but not completely surround the telescoping legs 104 to facilitate the carrying of stand 100 into the field. For example, as shown in FIGS. 1 and 3, footrest 206 attaches to a single telescoping leg 104a to provide a lightweight footrest 206. In FIGS. 2 and 4, footrest 206 extends about each telescoping leg 104 to provide the operator the ability to rotate about in any direction on seat 118.

FIG. 3 also shows the portable observation stand system 300 comprising the stand 100, the backrest 302 coupled to seat 118, and/or a blind 304. The stand 100 can comprise additional accessories that can be removably attached to the portable observation stand system 300. This way, system 300 can be customized and individualized for an operator's observational and/or hunting preferences. For example, an observer of wild birds may choose to include a stationary seat 118 with the backrest 302 and the footrest 206 extending entirely about platform 102. A hunter may choose to include a rotatable seat 118 that can rotate about the pivot axis 126 with no backrest 302 and a smaller footrest 206 coupled to a single telescoping leg 104 to reduce the weight of the system 300 that is carried into the field and/or moved from one location to another during the course of the hunt.

In some aspects, a hunter may choose to incorporate the blind 304 that can be coupled to platform 102. The blind 304 can extend at least partially about platform 102, surround platform 102, and/or entirely cover platform 102, stand 100, and/or system 300. This configuration can be customized by the hunter's preference and hunting style. The three or more telescoping legs 104a,b,c can be rotatably coupled to platform 102 at the pivotable joint 110 and extended into the extended and locked position 112 configured to support the operator on seat 118 and obstruct the operator from the observation of wild animals in the area by elevating the operator above the ground. In various aspects, each telescoping leg 104 can rotate between the collapsed position 502 (FIG. 5) and the locked position 112 to facilitate assembly of the system 300 in the field and transport (e.g., carrying the complete system 300 on the user's back to and from a desired location).

FIG. 4 is a top view of an aspect of seat 118. Seat 118 can be coupled to platform 102 and extend vertically upward away from platform 102. Various slots 202 can be disposed about and/or within seat 118 to receive and support the backrest 302 (FIG. 3). Seat 118 of FIG. 4 is rectangular (or square) and can support two or more operators. For example, seat 118 can be stationary and support two operators oriented in a fixed direction relative to stand 100 and/or platform 102. In some aspects, seat 118 can be rectangular and rotatable about the pivot axis 126. For example, seat 118 can be configured for a single operator and provide space to accommodate equipment (e.g., firearm or bows, ammunition, visors, range-finders, binoculars, etc.) on either side of the operator. In some aspects, seat 118 can comprise a storage box or other removable accessory to safely lock, store, and/or transport various accessories. The storage box and removable accessories engage slot 202, e.g., with an insert that affixes and couples the accessories to the seat 118 and/or rung 114. The accessories can be detached from slot 202 during transport or affixed and secured within slot 202 and transported in the affixed state.

One accessory that can be coupled to seat 118 and/or platform 102 of system 300 (FIG. 3) is the backrest 302. Seat 118 can comprise one or more slots 202, and the backrest 302 can comprise a projection that can be inserted into one or more of the slots 202 to support the backrest 302. Other accessories can be configured to couple to the slots 202 such that seat 118 can be accompanied by a storage box, a firearm or bow, binoculars, etc., and easily transported on the back of a user when the system 300 is in the collapsed position 502 (FIG. 5).

FIG. 5 is a perspective view of an operator carrying the portable observation stand 100 and/or system 300 in the collapsed position 502. In various aspects, the system 300 can be lightweight, such that the stand 100 can weigh less than 100 pounds, less than 75 pounds, less than 50 pounds, or less than 25 pounds. For example, the system 300 can be adapted to weigh more or less by the various accessories included with the stand 100 in the system 300. The system 300 and/or stand 100 may be less than 100 pounds to facilitate an operator carrying the stand 100 on their back without assistance. In addition, other equipment, such as firearms, bows, binoculars, etc., can be transported by the operator.

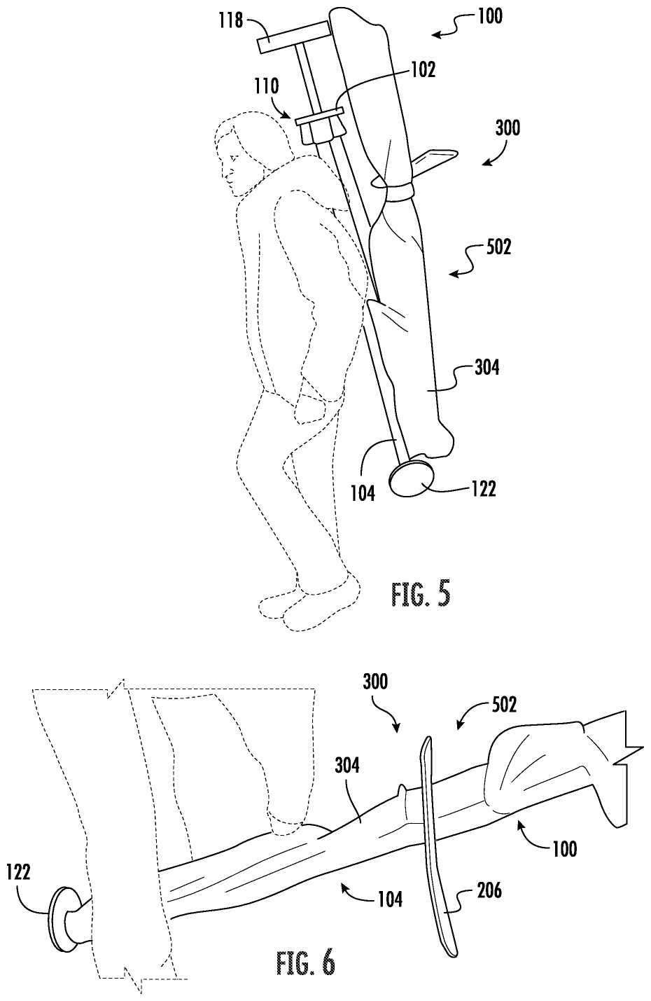

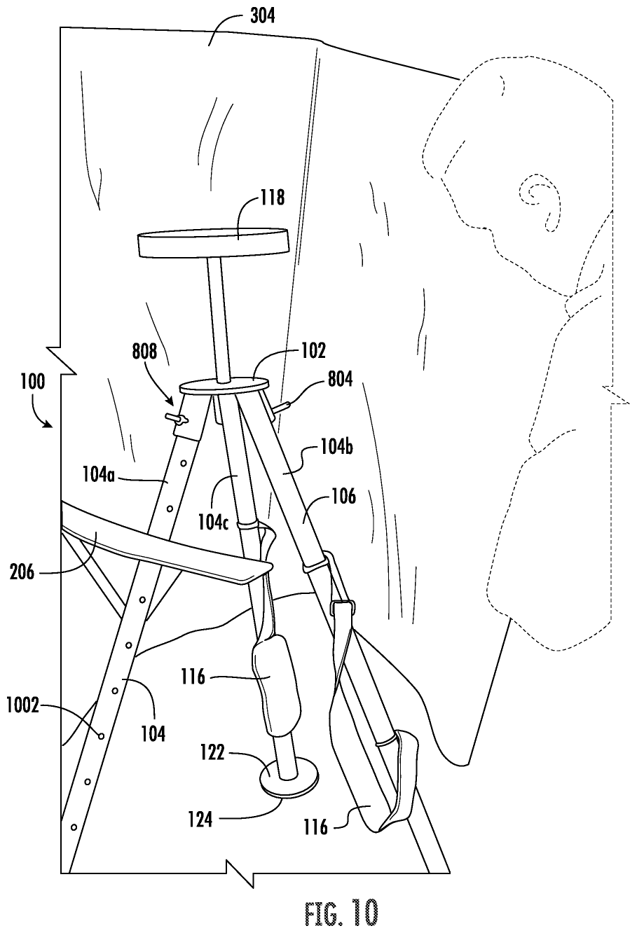

FIGS. 6 through 12 show the method of erecting the portable observation stand 100. Straps 116 (FIG. 10) can facilitate carrying the stand 100 in the collapsed position 502, e.g., as shown in FIG. 5. FIG. 6 shows the step of removing the stand 100 from the operator's back when arriving at a desirable location in the field. FIG. 7 shows the telescoping legs 104 of the portable observation stand 100 rotated from the collapsed position in FIG. 6 to the open unextended position shown in FIG. 7. In this configuration, the operator can attach and/or adjust seat 118 to platform 102 and rotate each telescoping leg 104.

FIG. 8 shows an operator of the portable observation stand 100 connecting the first telescoping leg 104a in a loosened position 802. Each of the telescoping legs 104 can comprise a threaded fastener 804 comprising a stud with threads coupled to a nut rotatable over the stud. The threaded fastener 804 can be tightened to secure the telescoping leg 104 to platform 102. That is, tightening the threaded fastener 804 can secure the telescoping leg 104 in the extended position so that the telescoping leg 104 can be extended and support the operator in the elevated stand 100. The locked position 808 of the threaded fastener 804 locks the telescoping leg 104c relative to the platform 102

FIG. 9 illustrates the portable observation stand 100 comprising an adjustable connection of the telescoping leg 104 in the tightened position. For example, two telescoping legs 104 may be in the loosened position, and one telescoping leg 104 in FIG. 9 is in the tightened position. In various aspects, the threaded fastener 804 can extend through the pivotable joint 110 coupling the telescoping leg 104 to the platform 102. The operator can tighten the threaded fastener 804 to move the telescoping leg 104 radially outward from platform 102. As the telescoping leg 104 moves, the pivotable joint 110 can be secured and moved from the collapsed position 502 (FIG. 5) to the locked position 112 (FIG. 1). The movement of the telescoping leg 104 secures the telescoping leg 104 in the locked position 112 to support platform 102 and seat 118 (FIG. 1). In some aspects, the platform 102 can define the angle of the pivotal joint 110 formed when the telescoping leg 104 is secured in the locked position 112.

As shown in FIGS. 8 and 9, the locked configuration (e.g., the locked position 808) secures the orientation of each telescoping leg 104 relative to the platform 102 and ensures that the telescoping legs 104 are oriented in an angled or pivoted direction relative to pivot axis 126 (FIG. 1). As shown, this gives the telescoping legs 104 a triangular configuration each extending radially outward from the pivot axis 126. The feet 122 extend outward to form a larger circumference encircled by the feet 122 as the telescoping legs 104 are extended and locked in the locked position 808.

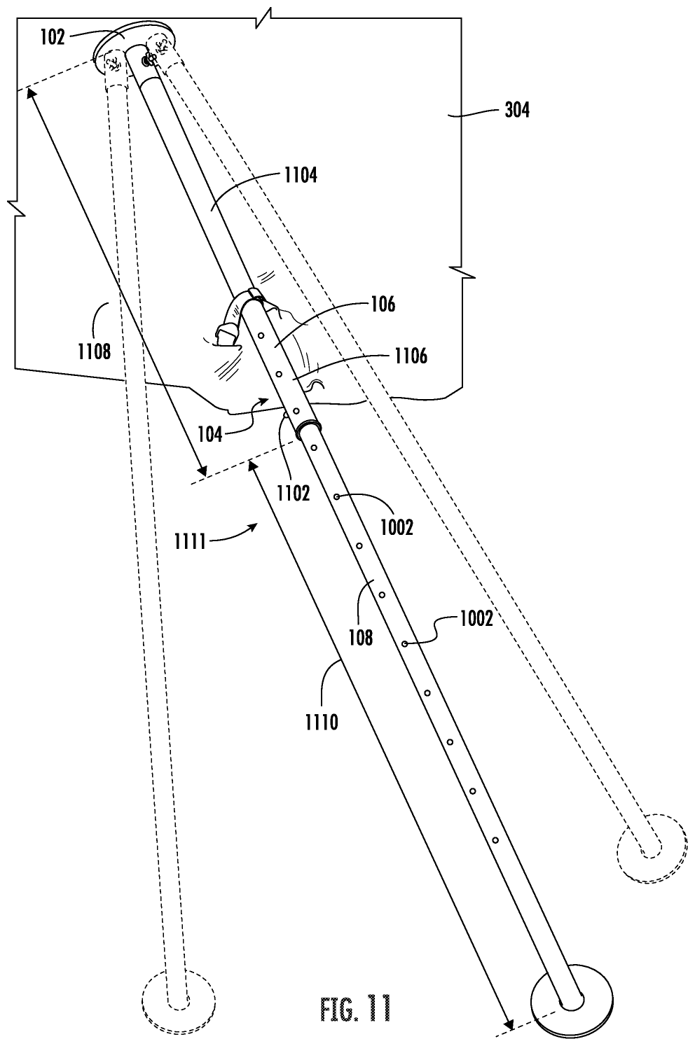

FIG. 10 shows the portable observation stand 100 in the open unextended position where each telescoping leg 104 can be in a tightened position but fully retracted. The footrest 206 is shown on the first telescoping leg 104a, and a pair of straps 116 are coupled to each of the other two telescoping legs 104b,c. As shown in FIG. 10, the threaded fasteners 804 coupling the telescoping legs 104 to the platform 102 extend radially outward from the pivot axis 126 (FIG. 1). A plurality of fastener openings 1002 can extend along the first segment 106 and the second segment 108 (FIG. 11) of each telescoping leg 104. The fastener openings 1002 can extend through the telescoping leg 104 (e.g., first segment 106 and second segment 108) in a circumferential direction of a circle defined between a center of each leg 104 and that is coaxial with the pivot axis 126. The fastener openings 1002 can be approximately perpendicular to the axial axis 120 of the telescoping leg 104. In this way, one or more rungs 114 (FIG. 1) can be attached to the telescoping leg 104 in opposed directions extending on either side of the telescoping leg 104 and enhance an operator's ability to climb up the telescoping leg 104 to the platform 102.

FIG. 11 shows a telescoping leg 104 being extended from a retracted position 702 (FIG. 2) into an extended position 1111. A clip 1102 can be inserted through a hole (e.g., fastener opening 1002) in the first segment 106 and aligned through a corresponding hole (e.g., fastener opening 1002) in the second segment 108 to extend the telescoping leg 104. When the telescoping leg 104 is extended. In some aspects, a cotter pin can be rotated about an outer surface 1104 of the first segment 106 and locks the clip 1102 and prevents the inadvertent collapse or retraction of the telescoping leg 104, e.g., by moving the second segment 108 within the first segment 106.

In various aspects, a plurality of fastener openings 1002 in the first segment 106 and the second segment 108 of each telescoping leg 104 can be aligned to extend/retract the telescoping legs 104. The second segment 108 telescopes within the first segment 106 to extend and/or retract the telescoping legs 104. The first segment 106 and the second segment 108 can be selectively locked in a desired position by the clip 1102. The plurality of fastener openings 1002 can be spaced along the first segment 106 and/or the second segment 108 of each telescoping leg 104. The first segment 106 has a first length 1108 and the second segment 108 has a second length 1110, such that the total length of the telescoping leg 104 can be adjusted as the second segment 108 telescopes within the first segment 106 to extend and/or retract each telescoping leg 104.

For example, the total length of each telescoping leg 104 is determined by the sum of the first length 1108 and the second length 1110. The total length can vary from on leg (e.g., 104a) to another (e.g., 104b and/or 104c). In addition, as the second segment 108 telescopes within the first segment 106, the first length 1108 of the first segment 106 can be different (e.g., not equal) to the second length 1110 of the second segment 108. The first length 1106 can have a length ratio of ¼, ½, ¾, 1, 1¼, 1½, 1¾, 2, or greater than the second length 1108 to great. In this configuration, the offset can make different fastener openings 1002 available to couple a rung 114 (FIG. 1) to the telescoping leg 104. In other embodiments, the offset enables various heights and uneven adjustments to each telescoping leg 104. For example, the stand 100 can comprise three different telescoping legs 104 each extended to a different length to keep seat 118 (FIG. 1) approximately level, even on sloped or uneven terrain.

In some aspects, the removable rung 114 can comprise a projection, the same as or similar to clip 1102, that can be inserted through the plurality of fastener openings 1002. The projection or clip 1102 can couple rung 114 to telescoping leg 104 in the extended position to facilitate an operator traversing and/or climbing the rungs 114 coupled and secured on the telescoping leg 104.

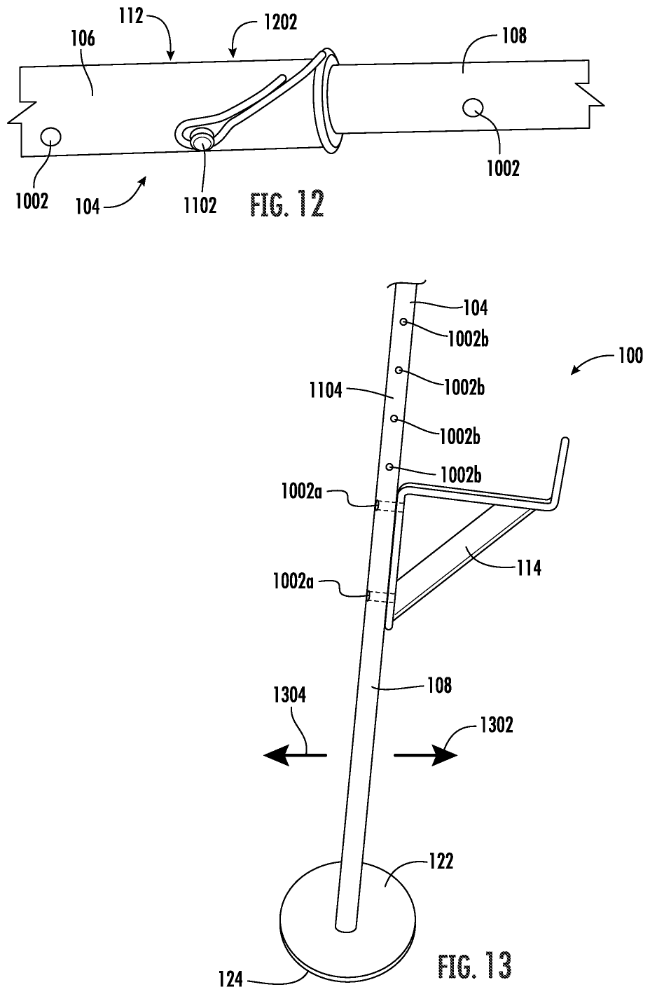

FIG. 12 shows clip 1102 and cotter pin 1202 in a locked position 112. Clip 1102 is extended through an aligned pair of the fastener openings 1002 of the first segment 106 and the second segment 108 to secure the telescoping leg 104 in the locked extended position. The cotter pin 1202 can extend about the outer surface 1104 of the first segment 106 and the second segment 108 or include a bent wire extending through a pinhole of the clip 1102.

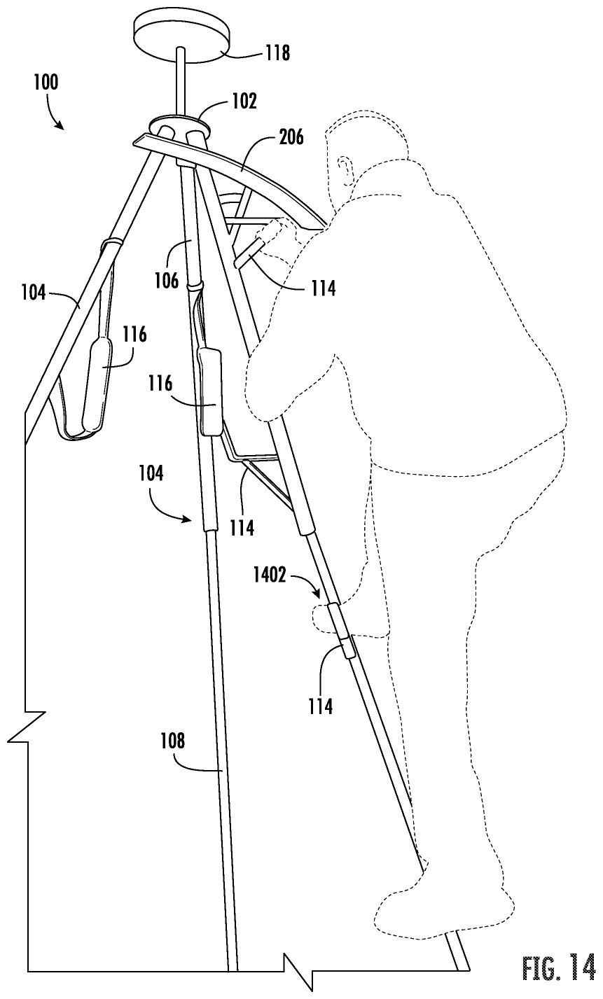

FIG. 13 shows a step formed by rung 114 when coupled to the telescoping leg 104 of the portable observation stand 100. A distal end of the second segment 108 opposite platform 102 can be coupled to a metallic foot 122, and a rubber guard 124 can extend under the foot 122. The foot 122 and the guard 124 can serve to distribute weight on a broader area of the ground. In some aspects, the material of the guard 124 can provide a damping and/or stabilizing effect of the telescoping leg 104 on the ground. For example, each second segment 108 of each telescoping leg 104 can comprise the foot 122 coupled to the guard 124 to distribute forces more evenly and enhance the stability of the portable stand 100.

In various aspects, at least one of the telescoping legs 104 can comprise a series of fastener openings 1002a, configured to receive a plurality of rungs 114. A second set of fastener openings 1002b can run in a direction perpendicular to the fastener openings 1002a and facilitate the attachment of various accessories (e.g., straps 116 and/or footrest 206, etc.). In some aspects, rungs 114 can be joined and/or used to form steps, seats 118, footrests 206, etc. by couping one of these components to the rung 114. Alternating steps can extend in opposing directions. For example, a first rung 114 can form a step oriented in a first circumferential direction 1302, and a second rung 114 can form a step oriented in a second circumferential direction 1304 opposite the first circumferential direction 1302.

FIG. 14 illustrates an operator climbing a series of steps 1118 coupled to a telescoping leg 104 of the portable observation stand 100. As shown, steps 1118 can be coupled to the first segment 106 and the second segment 108 of the telescoping leg 104. In FIG. 14, the operator's feet are resting on the steps 1118, formed by rungs 114, secured on the second segment 108, and the operator's hands are gripping the steps 1118, formed by the rungs 114 secured on the first segment 106 of the telescoping leg 104 used to ascend/descend the telescoping leg 104. The straps 116 can be coupled to the remaining telescoping legs 104 and can be free to support accessories and can be used again when the stand 100 is collapsed and carried out of the field by the operator.

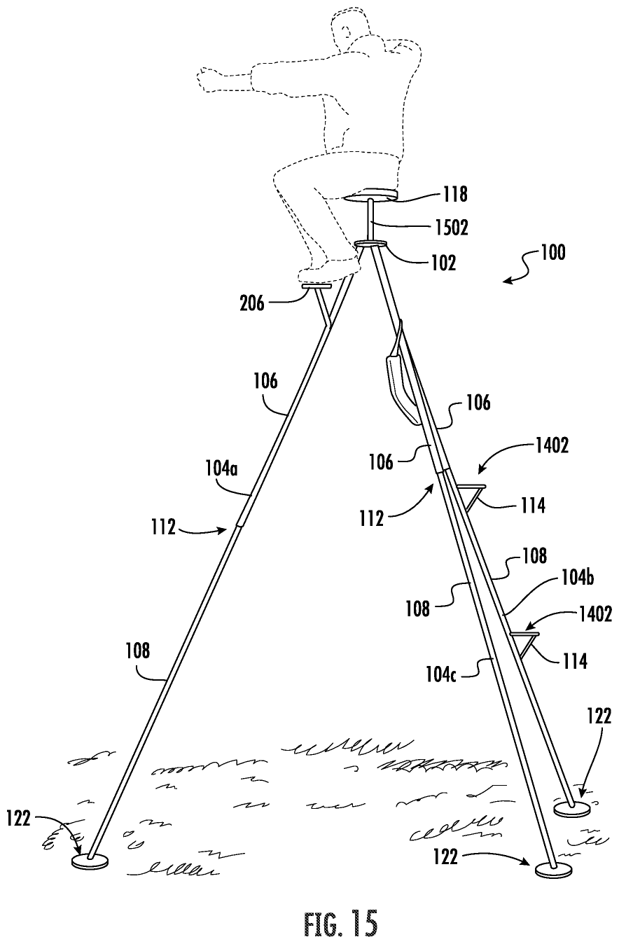

FIG. 15 is a side perspective view of an operator seated in seat 118 of the portable observation stand 100. The seat 118 and the backrest 302 (FIG. 3) can freely pivot about the pivot axis 126 (FIG. 1) that can extend centrally and vertically between at least three telescoping legs 104a,b,c. Stated differently, the pivot axis 126 can extend centrally through a post 1502 supporting seat 118. FIG. 15 shows the ability of an operator to operate a bow while seated in seat 118. Additional accessories, such as a footrest 206, can be used by the operator to facilitate and/or stabilize the operation of the bow or firearm. In some aspects, the accessories can be utilized by the operator to store the bow or firearm while observing the field or to store other tools or accessories, such as food, scopes, binoculars, ammunition (e.g., bullets or arrows), etc.

In various aspects, methods of erecting a portable observation stand 100 are described. The method can comprise carrying a platform 102 coupled to a first telescoping leg 104a, a second telescoping leg 104b, and a third telescoping leg 104c. For example, each leg 104 can be coupled to platform 102 and locked. Each telescoping leg 104 can be rotated and secured into a locked position 112 relative to platform 102. The operator can extend each telescoping leg 104. In various aspects, each telescoping leg 104 can be extended to a length needed to accommodate wet ground, uneven terrain, or a sloped installation of the stand 100. The operator can couple the second segment 108 of each telescoping leg 104 within the first segment 106 of the telescoping leg 104 to extend the telescoping leg 104 to a desired length.

In various aspects, the method can comprise attaching a first rung 114 to the first telescoping leg 104a in a first direction 1302 (FIG. 13) and attaching a second rung 114 to the first telescoping leg 104 in a second direction 1304 (FIG. 13) opposite the first direction 1302. The operator can climb the first rung 114 and the second rung 114 to reach seat 118. In some aspects, a foot 122 can be attached to each telescoping leg 104. The operator can also optionally attach seat 118 and/or blind 304 (FIG. 3) to the platform 102.

The description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B,” as used herein, means “only A, only B, or both A and B”; while the phrase “one of A and B” means “A or B.”

Unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal the front; “left” is that which is to the left of or facing left from a person sitting in the seat and facing towards the front; and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

One should note that conditional language, such as, among others, “can,” “could,” “might,” or “may,” unless specifically stated otherwise or otherwise understood within the context as used, is generally intended to convey that certain aspects include, while other aspects do not include, certain features, elements and/or steps. Thus, such conditional language is not generally intended to imply that features, elements, and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

1. A stand comprising:
a platform comprising a pivotable joint; and
a telescoping leg coupled to the platform at the pivotable joint and rotatable between a collapsed position and a locked position, the telescoping leg comprising:
a removable rung coupled to the telescoping leg;
a first segment of the telescoping leg; and
a second segment of the telescoping leg partially captured within and slidably supported by the first segment.

2. The stand of claim 1, further comprising a foot coupled to the second segment of the telescoping leg, the foot comprising a guard coupled to the foot, the guard configured to support the foot in wetlands.

3. The stand of claim 1, further comprising a fastener extending through the pivotable joint, wherein tightening the fastener moves the telescoping leg radially outward from the platform and moves the pivotable joint from the collapsed position to the locked position and secures the telescoping leg in the locked position.

4. The stand of claim 1, wherein the telescoping leg is a first telescoping leg, and the stand further comprises a second telescoping leg and a third telescoping leg, each telescoping leg comprising the first segment and the second segment partially captured within and slidably support by the first segment of the telescoping leg.

5. The stand of claim 4, wherein the second segment of each telescoping leg comprises a foot coupled to a guard.

6. The stand of claim 1, further comprising a plurality of fastener openings in the first segment and the second segment of the telescoping leg, wherein the plurality of fastener openings are spaced by a first length in the first segment than a second length in the second segment of the telescoping leg.

7. The stand of claim 6, wherein the first length is not equal to the second length.

8. The stand of claim 6, wherein the removable rung comprises a projection inserted through the plurality of fastener openings to couple the removable rung to the telescoping leg.

9. A portable observation stand, comprising:
a platform comprising a pivotable joint;
a blind coupled to the platform and extending at least partially about the platform; and
at least three telescoping legs coupled to the platform at the pivotable joint, each telescoping leg being rotatable between a collapsed position and a locked position, each telescoping leg comprising:
a first segment of the telescoping leg; and
a second segment of the telescoping leg partially captured within and slidably supported by the first segment.

10. The portable observation stand of claim 9, wherein the platform, the blind, and the at least three telescoping legs weigh less than 100 pounds.

11. The portable observation stand of claim 9, further comprising a footrest coupled to the platform and extending at least partially about the platform.

12. The portable observation stand of claim 9, further comprising at least three feet, each foot coupled to an end of each telescoping leg opposite the platform.

13. The portable observation stand of claim 9, wherein at least one of the telescoping legs comprises a series of fastener openings configured to receive a plurality of steps, wherein a first step is oriented in a first circumferential direction and a second step is oriented in a second circumferential direction opposite the first circumferential direction.

14. The portable observation stand of claim 9, further comprising a seat coupled to the platform and extending vertically upward from the platform.

15. The portable observation stand of claim 14, further comprising a backrest coupled to the seat, wherein the seat comprises a slot, and the backrest comprises a projection inserted into the slot.

16. The portable observation stand of claim 15, wherein the seat and the backrest each pivot about a pivot axis extending centrally between the at least three telescoping legs and through the seat.

17. A method of erecting a portable observation stand comprising:
carrying a platform coupled to a first telescoping leg, a second telescoping leg, and a third telescoping leg;
rotating each telescoping leg into a locked position relative to the platform; and
extending each telescoping leg by coupling a second segment of each telescoping leg captured within a first segment of each telescoping leg.

18. The method of claim 17, further comprising:
attaching a first rung to the first telescoping leg in a first direction;
attaching a second rung to the first telescoping leg in a second direction opposite the first direction; and
climbing the first rung and the second rung.

19. The method of claim 17, further comprising:
attaching a first foot to the first telescoping leg;
attaching a second foot to the second telescoping leg; and
attaching a third foot to the third telescoping leg.

20. The method of claim 17, further comprising attaching a seat and a blind to the platform.
